(19) United States
(12) Patent Application Publication
(10) Pub. No.: US 2018/0092143 A1
(43) Pub. Date: Mar. 29, 2018

(54) SETUP DEVICE FOR SHARING CONTENT OVER A NETWORK

(71) Applicant: Sriakhil Gogineni, Canton, MI (US)

(72) Inventor: Sriakhil Gogineni, Canton, MI (US)

(21) Appl. No.: 15/614,605

(22) Filed: Jun. 5, 2017

Related U.S. Application Data
(60) Provisional application No. 62/345,626, filed on Jun. 3, 2016.

(51) Int. Cl. H04W 76/02; H04W 48/14

(52) U.S. Cl. CPC H04W 76/023; H04W 4/008; H04W 48/14; H04W 76/02

(57) ABSTRACT

A system and methods for device setup, discovery, connectivity and sharing content, motivated by ease of use.

### CROSS REFERENCE TO RELATED APPLICATIONS

This application claims the benefit of U.S. Provisional Patent Application No. 62/345,626, filed Jun. 3, 2013. The present application is based on and claims priority from this application, which is incorporated by reference in its entirety.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the Patent and Trademark Office file or records, but otherwise reserves all copyright rights whatsoever.

### TECHNICAL FIELD

The present invention relates to network, devices and manipulating data over a network and more particularly to device setup and sharing content over a network.

### BACKGROUND ART

The following is a tabulation of some prior art that presently appears relevant:

### U.S. Patent Documents

| Patent Number | Kind code | Issue Date | Patentee |
|---|---|---|---|
| 6167446 | | 2000 Dec. 26 | Lister et al. |
| 7281034 | B1 | 2007 Oct. 7 | Eyal |
| 7487262 | B2 | 2009 Feb. 3 | Cardina et al. |
| 7769961 | B2 | 2010 Aug. 3 | Kottomtharayil et al. |
| 7886033 | B2 | 2011 Feb. 8 | Hopmann et al. |
| 8856045 | B1 | 2014 Oct. 7 | Patel et. al |
| 9392050 | B2 | 2016 Jul. 12 | Voit et al. |
| 2016/0011879 | A1 | 2016 Jan. 14 | Wang et al. |

### Foreign Patent Documents

| Patent Nr. | Cntry. Code | Kind code | Pub. Date | App or Patentee |
|---|---|---|---|---|
| 3110227 | EP | A1 | 2016 Dec. 28 | Wang et al. |

The number of network connected devices is rapidly increasing. The most popular global network is the Internet and the standard agreed upon to address nodes on this network, internet protocol version 4 (IPv4) has exhausted its available addresses, slightly less than 4.3 billion addresses. During the inception of the Internet this was theorized to be sufficient for every computer on the planet, however no one foresaw the coming of mobile computers, smartphones which have dwarfed the number of traditional computers. In addition to computers there are computer accessories that are network connected including but not limited to, routers, printers, scanners, etc. and a further explosion of everyday products are now becoming network connected such as but not limited to, lightbulbs, speakers, garage door openers, doorbells, etc. These everyday network connected devices are referred to as the Internet of Things (IoT) and often live in local networks behind a gateway connected to the Internet and further contribute to the ever growing number of network connected devices people are using.

Setup and use of networked devices, whether business or consumer products, is a troublesome, time-wasting endeavor. When a device is connected to a network, it must first be configured with an address on the network before it can be used. On commonly used networks in homes and business, devices can obtain a dynamic internet protocol (IP) address from the name server (NS) automatically using existing Dynamic Host Configuration Protocol (DHCP) or a static address, manually assigned by the network administrator. In the former case, users must guess and check each possible IP address from all possible values for the network, and this method is still not guaranteed to work if the device does not respond to the user's method of query. In the latter case, there are numerous values which could be misconfigured which further complicate setup and prevent use of the device. A device's user manual may contain a static address, (e.g. 192.168.1.1) and request the user to attempt to connect to it and further configure the device. However, this method is not guaranteed to work and I have found this to be particularly problematic for non-technical users who must then call an expert for assistance. Furthermore, with the ever-increasing number of devices on the network, there is an increasing chance of collision, that is multiple devices having the same address. This will render either or both devices, inoperable. Other proposed solutions require devices to have a connection to the internet and connect to a third party server. If the internet connection or the third party server are unreachable, the device are either inoperable or revert to a state which is difficult to use.

Existing attempts to address this issue require monitoring and analyzing the network traffic, U.S. Pat. No. 6,167,446 (2000), U.S. Pat. No. 7,487,262 (2009), U.S. Pat. No. 9,392,050 (2016). Monitoring and analyzing network traffic can introduce latency and slow down the performance of the network. Some types of traffic which are encrypted cannot be analyzed, or if they are it will introduce a security risk by decrypting traffic by another device on the network who is not the intended recipient. Other methods require complex pre-configuration or are limited to certain hardware, U.S. Pat. No. 8,856,045 (2014), 2016/0,011,879. The method, shifts the burden of configuration onto the manufacturer and network administrator who must consider many possible network and device configurations, many of which will not be used and with the nearly infinite configurations, still does not guarantee ease of use for non-technical users. Furthermore, requiring specialized hardware is not readily applicable to millions of existing devices so they will not be able to benefit from automated setup. Still other methods are limited in scope to specific devices or types of shareable content, U.S. Pat. No. 6,167,446 (2000), U.S. Pat. No. 7,281,034 (2007), U.S. Pat. No. 7,769,961 (2010), U.S. Pat. No. 7,886,033 (2011), U.S. Pat. No. 8,856,045 (2014). A solution limited to specific devices or types of content is no solution at all. With millions of existing devices, its critical that a solution cover as many as possible while allowing the user to share whatever content their hearts desire.

### SUMMARY

In accordance with one embodiment of a system and methods for device setup and sharing content over a network, the system comprises of devices which register their configuration. A user can then easily discover and connect to devices using an application. The user may then select content to present which is then sent to the device and presented as appropriate for the content. The device can then send feedback to the user with information in respect to the content. The device can then accept interaction requests from the user, be sent new content, or the user can end the sharing session.

Accordingly several advantages of one or more aspects are as follows: to provide automatic setup of devices on a network, to enable simple, consistent configuration of devices, to easily share and present content of various types and overall to enable an easy to use experience for users. Furthermore, network administrators and device manufacturers, do not need to consider a multitude of configurations which involve handling complex configurations. Simple parameters may be set which allow for seamless automatic configuration.

The features and advantages described in this summary and the following detailed description are not all-inclusive. Many additional features and advantages will be apparent to one of ordinary skill in the art in view of the drawings, specifications and claims.

### BRIEF DESCRIPTION OF THE DRAWINGS

FIG. 1 is a system diagram of a setup device system, in accordance with an embodiment of the invention.

FIG. 2A is a flowchart illustrating the communication between a setup device and an orchestration server for device registration in accordance with an embodiment of the invention.

FIG. 2B is a flowchart illustrating the communication between a client device, a setup device and an orchestration server for sharing content in accordance with an embodiment of the invention.

FIG. 3 is a table illustrating the element names and element value types in a registration request between a setup device and an orchestration server in accordance with an embodiment of the invention.

FIG. 4 is a system diagram of a setup device system, with an additional client device connected to a separate network, in accordance with another embodiment of the invention.

FIG. 5 is a system diagram of a setup device system, with parts of the system on a separate network segment, in accordance with another embodiment of the invention.

FIG. 6 is a system diagram of a setup device system, with parts of the system in a single device, in accordance with another embodiment of the invention.

FIG. 7 is a block diagram of an exemplary orchestration server, in accordance with one embodiment of the invention.

FIG. 8 is a block diagram of an exemplary client device, in accordance with one embodiment of the invention.

FIG. 9 is a block diagram of an exemplary setup device, in accordance with one embodiment of the invention.

FIG. 10 is a system diagram of a setup device system, illustrating an example of real world usage with multiple setup devices and other devices, in accordance with another embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

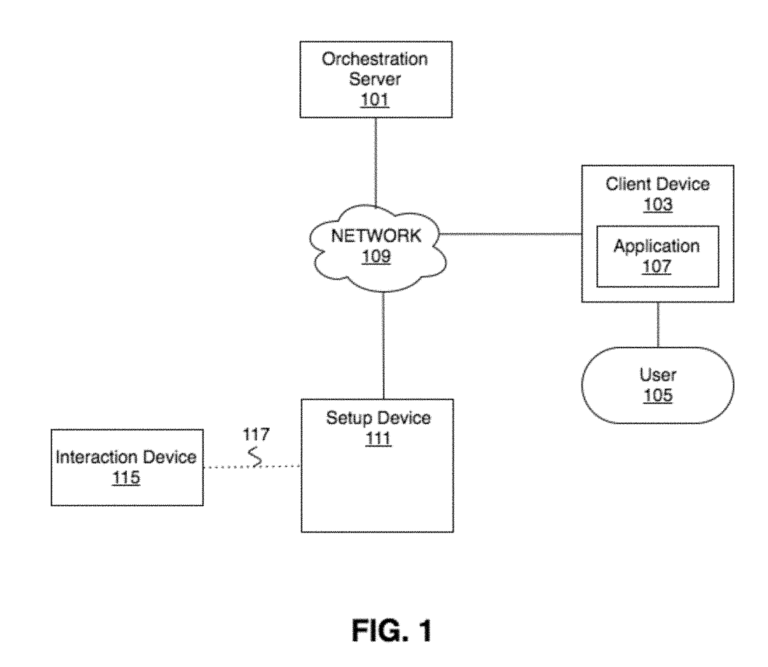

### System Overview—One Embodiment—FIGS. 1, 7, 8, 9

One embodiment of the system and methods for device setup and content sharing over a network is illustrated in FIG. 1. The system consists of a network 109 of connected devices: an orchestration server 101, which orchestrates device setup with a setup device 111, and allows a user 105, using a client device 103, to easily discover devices on the network 109. Discoverable devices may be listed as either the setup device 111, or the interaction device 115. Each entity connected to the network may have a unique address (e.g. uniform resource locator (URL), an IP address, a media access control (MAC) address, etc). In one embodiment, the network is the Internet. The network 109, can also utilize dedicated of private communication links (e.g. WAN, MAN or LAN) that are not necessarily part of the Internet. The network uses standard communications technologies and/or protocols.

Users 105 use respective client devices 103, to access and interact with the orchestration server 101. Client devices 103 include computer software and hardware allowing users to interact with other network systems. A client device 103 can be any device that is or incorporates a computer such as a personal computer (PC), a desktop computer, a laptop computer, a notebook, a smartphone, or the like. FIG. 8 shows an exemplary client device in accordance with one embodiment. A computer is a device having one of more general or special purpose processors, e.g. a processing unit 801, memory 803, volatile and non-volatile, sometimes referred to as storage herein referred to as memory, and wired and/or wireless networking components, e.g. communications unit 805. In the embodiment in FIG. 8., the communications unit consists of WiFi, cellular and wired mechanisms 807, and Bluetooth™ mechanisms 809. The device executes an operating system, for example, a Microsoft™ Windows™-compatible operating system (OS), Apple™ OS X™ or iOS™, a Linux™ distribution, or Google's™ Android OS™. The user 105 interacts through an application 107 running on the client device 103. In some embodiments, the application 107 may be a web browser, such as Microsoft Internet Explorer™ Mozilla Firefox™ Google Chrome™ Apple Safari™ and/or Opera™ as an interface to interact with the system. In other embodiments, the application 107, may be a native application built specially for the client device. It is preferably in terms of users experience that the application be familiar for the user for a client device, thus different users and client devices may prefer to interact via different applications.

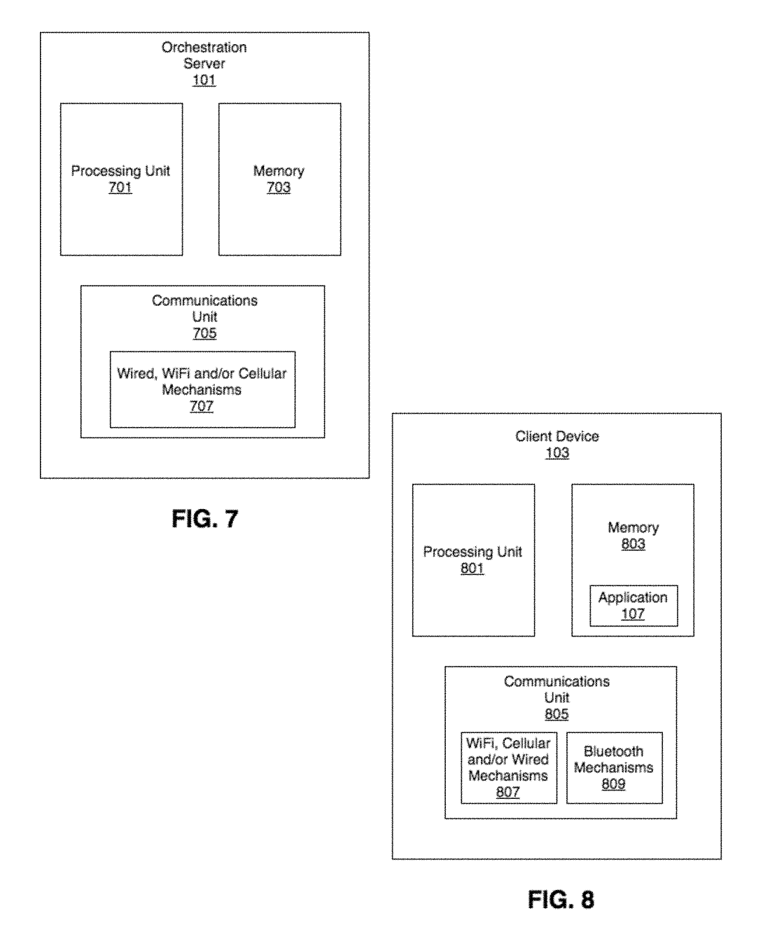

The orchestration server 101 registers devices connected to the network 109 and maintains a registry of devices and their configuration. It serves as a centralized location for device information and configuration which may be easily modified by a non-technical user. The orchestration server is easily found using a commonly familiar address, (e.g. www.getsugarcube.com/project or sugarcube.local) which provides a frustration free experience for users. In one embodiment, if the orchestration server is connected to the Internet or private network with a domain name server (DNS), this is accomplished by registering a domain name and registering the server with the domain name server (DNS). In another embodiment, the orchestration server may be automatically registered with the local name server using common multicast broadcast methods or manually assigned by the network administrator which enables users to easily discover the orchestration server using the local naming scheme. In another embodiment, if the orchestration server also handles NS responsibilities, it may provide a familiar name by creating a NS record for itself. The orchestration server 101 can be any device that is or incorporates a computer as similarly described above. FIG. 7 shows an exemplary orchestration server in accordance with one embodiment. The orchestration server 101 consists of a processing unit 701, memory 703, volatile and non-volatile, and a communications unit 705. In this embodiment, the communications unit 705 consists of wired, WiFi and/or cellular mechanism 707.

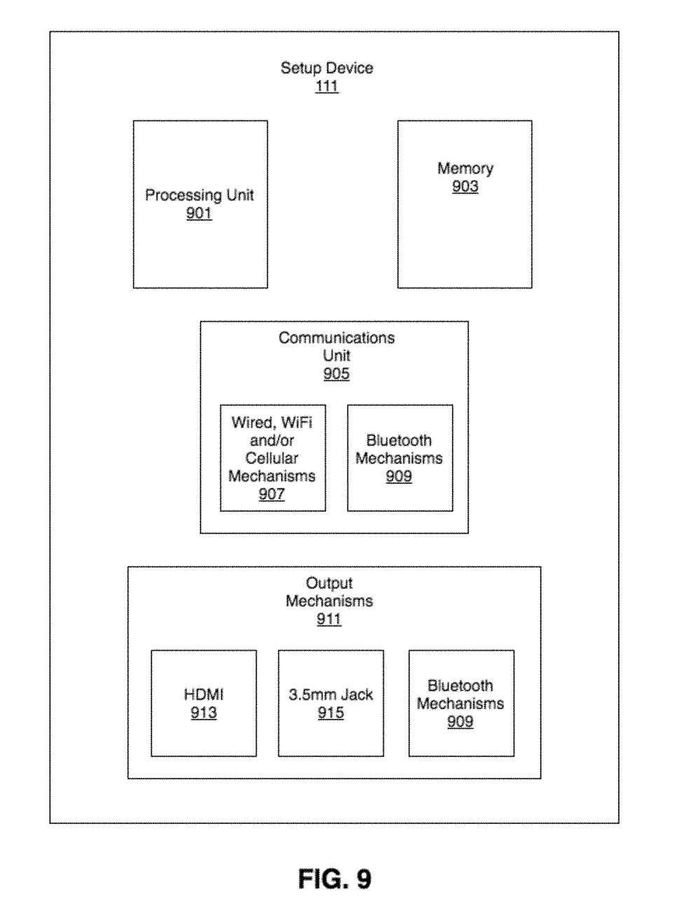

A setup device 111 is connected to an interaction device 115 through an interaction connection 117. In this embodiment, the setup device is connected to the network 109 through wired or wireless methods. The interaction device 115 may be any device which can present content. If the content is visual, a type of display, if the content is auditory, a speaker, if the content is configuration then the appropriate device to use that configuration, etc. In this embodiment for the purposes of illustration we shall define the interaction device 115 to be a TV. The interaction connection 117 is the appropriate connection between the setup device 111 and the interaction device 115 to transfer content. If the interaction device were a TV, appropriate connections may be HDMI™, DisplayPort™, if the interaction device is a speaker, then a 3.5 mm audio jack or RCA connection may be valid, if the interaction device is a color changing LED lightbulb, then a Bluetooth™ or WiFi connection may be appropriate, etc. In this embodiment, as we have defined the interaction device 115 to be a TV, an appropriate interaction connection 117 is a HDMI™ connection. The setup device 111 can be any device that is or incorporates a computer as previously described. FIG. 9 shows an exemplary setup device 111 in accordance with one embodiment. The setup device 111 consists of a processing unit 901, memory 903, a communication unit 905, to communicate with the network and output mechanisms 911 to communicate with the interaction device 115. In this embodiment, the communications unit 905 consists of wired, WiFi and/or cellular mechanisms 907 and Bluetooth™ mechanisms 909. The output mechanisms 911 in this embodiment are HDMI 913, 3.5 mm jack 915 and Bluetooth Mechanisms™ 909. The HDMI connection may be connected to a TV used as an interaction device, the 3.5 mm jack used to connect to speakers and the Bluetooth™ to connect to a multicolor LED light bulb. As shown in this embodiment, modules, such as the Bluetooth mechanisms 909, in the communication unit 905 are not mutually exclusive from the output mechanisms 911. The setup device 111 also handles interaction with the user, including but not limited to, feedback from presenting content and/or additional device specific configuration. This varies depending on the capabilities of the setup device and connected interaction device.

An interaction device 115 may be any device that is not directly accessible via the network 109. Examples of interaction devices are: TVs, speakers, multicolor LED lightbulbs, routers/switches, door bells, locks, air purifiers, heaters, garage door openers, cooking appliances, thermostats, etc. The possibilities are varied and endless. A user 105 may desire to interact with the interaction device through sharing content. As previously discussed, content may be visual, auditory, configurations, text, tactile, etc. A user may share content to: a TV, by sending video or pictures; a speaker, by sending audio; a multicolor LED lightbulb, by sending the name of a color; a router/switch, by sending a configuration file; a doorbell, by receiving a notification when its pushed; a lock, by sending a request to open; an air purifier, by sending settings for fan speed; a heater, by sending the desired temperature; a garage door, by sending a request to open; a cooking appliance, by sending a request to turn on at a specified time; a thermostat, by receiving the current temperature and setting a new temperature; etc. The interaction device may have a method of interface to the setup device 111 via the interaction connection 117. The connection is appropriate for the interaction device 115 and setup device 111. In this embodiment, as previously discussed for the purposes of illustration the interaction connection 117 is defined as an HDMI connection. With the variety and multitude of interaction devices, it may be costly to replace them with network connected versions, thus it may be more cost effective to design a setup device with the appropriate interaction connection to be used directly with the interaction device, enabling the benefits of automatic setup and ease of use and sharing content.

### Operation—Device Setup

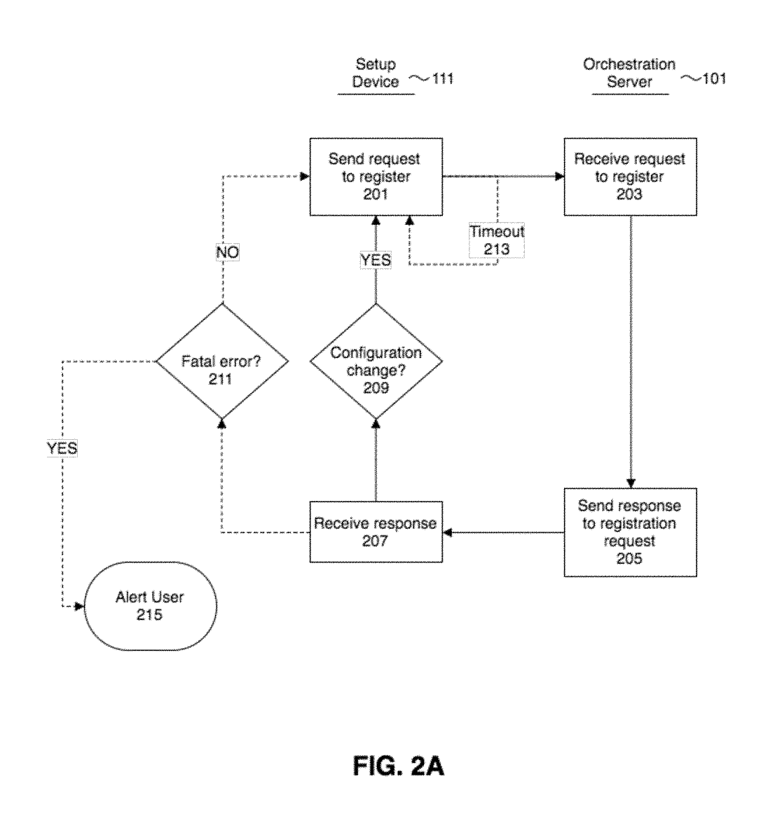

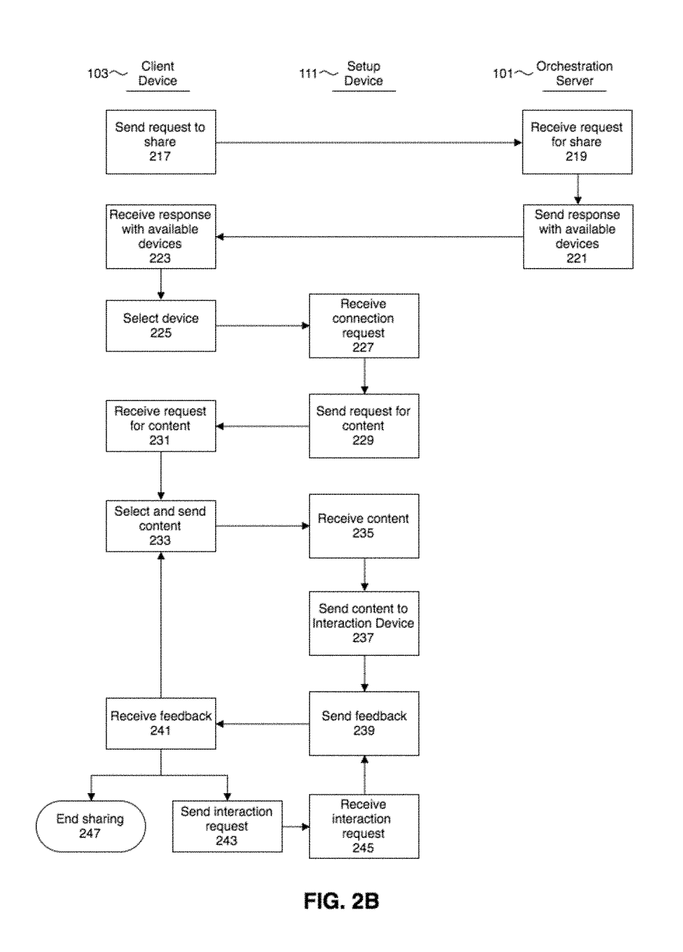

The manner of automating device setup is illustrated in a flowchart in FIG. 2A which is an embodiment of the device registration process. Upon connecting to the network, a setup device 111 registers with an orchestration server 101. In this embodiment, setup device 111 initiates a request to register with the orchestration server 101. The address of the orchestration server may be defined and stored in the setup device's non-volatile memory by the manufacturer or the network administrator, or it may be discovered by scanning through available network addresses. Scanning starts by taking the setup device's network address and iterating through nearby address and attempting to establish a connection on various commonly used ports. If there is no response on an address and port combination, there is no orchestration server or the server has chosen not to respond and the next addresses is attempted. Alternatively, a response may be return indicating a service exists at that address and port combination. The only way to know it is an orchestration server is with a proper response. A practitioner skilled in the art can determine which method is preferable based on the network and devices in question.

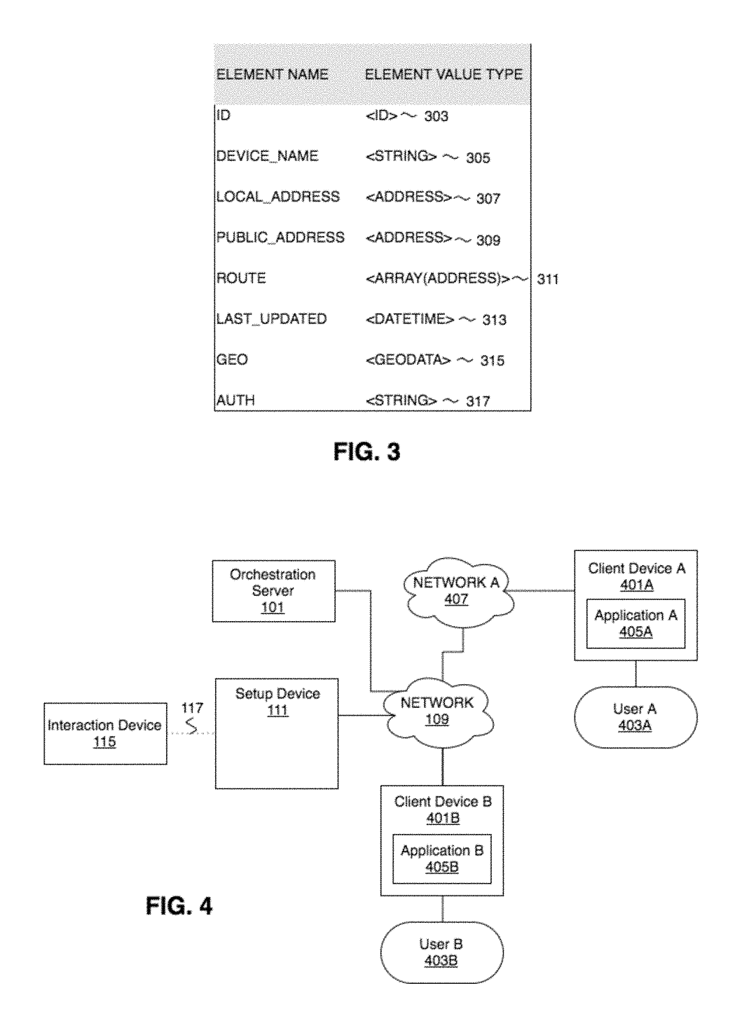

The setup device 111 connects to the orchestration server 101 and initiates a request to register 201. An embodiment of the information in the registration request is depicted in FIG. 3. The embodiment in FIG. 3. consists of elements in a structure with a pre-defined name and then the value and types, these consist of an ID 303 of the setup device 101 which should be a unique value among all devices, given a randomly generated alphanumerical string or number of that is at least 1 or more characters this is easily accomplished. For purposes of illustration and minimizing collisions, an ID of 64 bit—but not limited to, may be used, this allows for more than nine quintillion unique devices. A DEVICE_NAME 305 is a string used to refer to the device, this may be a set to a default by the manufacturer and later changed by the user to be something more familiar or refer to one or more of the interaction devices connected to the setup device. This helps improve the user experience by clearly differentiating multiple devices with recognizable names. A LOCAL_ADDRESS 307 which is the address of the setup device 111 on the local network, e.g. 192.168.1.125, or an IP address of a device on a home network behind a wireless router. This is also the address the setup device 111 obtains when connected to the network. A PUBLIC_ADDRESS 309 is the address of the setup device 111 which is accessible through a wider area network (WAN) or the Internet. In the example of a home network, this is the IP address assigned to you by your Internet Service Provider (ISP), or the WAN IP address on your wireless router. This available by making a request to an internet connected server which replies wait the address generating the request. Many such services exist, one is icanhazip.com. This service and other can also be run directly from the orchestration server 101. A ROUTE 311 is a list of all intermediate nodes with addresses between the setup device 111 and orchestration server 101 on the network 109. This assists with connection routing for client explained in the next section. It is a sequentially ordered list of addresses starting with lower numbers being closer to the setup device, ending with the address of the orchestration server 101. This is obtained by running the common traceroute command found in many operating systems and libraries familiar to one skilled in the art. The address and routing information assists with connecting the client device to the setup device and as well as determining authorized users among other features. These will be detailed in the next section relating to establishing a connecting with a client device and sharing content. A LAST_UPDATED 313 element is the current time in UTC in UNIX time format, other formats may be used as preferred. This helps determine the latest configuration, when configurations change and the configuration of the last working configuration. A GEO 315 element establishes the approximate GPS coordinates of the setup device. This is accomplished by numerous services which will respond to requests with the approximate longitude and latitude, one such service is freegeoip.net. This service can also be run from the orchestration server 101. This information is useful for automatically setting the date and time of the setup device and connected interaction device 115 further improving ease of use. An AUTH 317 element with a string security token is also included in the request. In addition to standard security practices known to practitioners of the art, such as Secure Sockets Layer (SSL) encrypted communication and other methods. Manufacturers can include asynchronous public private key cryptography or simpler synchronous key cryptography. In this embodiment, we will illustrate the simpler synchronous key cryptography, in which a secret key known only to the manufacturer or network administrator or owner of the setup device and/or orchestration server generates a secure string which is known only to both the setup device 111 and orchestration server 101. By sending this key with communications, both parties can reasonably guarantee they are trusted parties and bad actors cannot submit malicious requests or tamper with requests in transit as they are not privy to the key. Keys may be swapped once to deployed periodically to ensure best security practices or when there is potential for compromise. A key is generated via the OpenSSL library, which is a standard commonly used by those skilled in the art for security.

The orchestration server 101 receives the request to register 203 and verifies its validity by checking for a matching AUTH 317 value. Once it is verified to be correct, the orchestration server 101 updates its internal registry with the elements specified in the request FIG. 3. Once this process is completed the orchestration server 101 sends a response with the appropriate response 205 to the setup device 111 being either affirmatively for successful registration or negatively with an error describing the reason for failure, e.g. improper authentication, invalid fields, etc. If the proper registration request is received by the orchestration server 101 it is nearly always completed and the affirmative response is sent. In cases where the error is improper authentication from a new or unknown address, it may be beneficial to silently fail to avert alerting the malicious actor that their malicious attempt was not successful. Once the client device receives a response 207 it may halt further communication with the orchestration server until required. A timeout 213 occurs if no response is received within a certain time frame, approximately 15 seconds, which can be shorter or longer. The timeout 213 triggers the setup device 111 to retry to send the request to register using the commonly used exponential back off strategy. This involves doubling the wait time to retry a request upon each successive failure. The setup device 111 may also retry if a negative response was received 207 once the error has been corrected, or if the error is terminal 211, such as hardware error, may alert the user 215 via status lights, email or other methods.

When successfully registered, the setup device 111 waits for configuration changes 209 which can happen by changes related to the setup devices network connectivity or configuration changes made by the user or other similar events. This event will trigger the setup device 111 to send a new registration request with updated information 201 repeating the process just described and illustrated in FIG. 2A. For the purposes of illustration, this embodiment communicates with JavaScript Object Notation (JSON) format and uses SSL communication to provide a secure communication channel, other embodiments may use other formats and communication channels. Other embodiments may swap the roles of the setup devices 111 and orchestration server 101 by having the orchestration device initiates the registration request and the setup device respond to the request, using the same process as descried in the preceding section. This option is available to practitioners should the need arise due to network constraints.

### Operation—Client Device and User Experience

Users enjoy a simplified experience discovering and using devices by the process illustrated by the flow chart in FIG. 2B which is an embodiment of the device discovery, connection and content sharing process. A User 105 with respective client device 103 uses an application 107 which may be browser, native application or other intuitive interface. For the purposes of illustration in this embodiment, the application 107 is a browser. The user 105 sends a request to share 217 to the orchestration server 101 with the browser 107 via visiting a URL entered into the browser 107 (e.g. www.getsugarcube.com/project). The orchestration server 101 receives the request to share from the browser and verifies the client device 103 by matching the PUBLIC_ADDRESS 309 and ROUTE 311 which are obtained from the request to share 217. If the orchestration server 101 finds a matching PUBLIC_ADDRESS 309 in its registry of devices, it checks the ROUTE 311 array to determine if the client device 103 and devices are on the same internal network determined by matching subnets. Further checks can be done but are not limited to methods such as checking the MAC address of the client device or account credentials against a list of authorized users for each device. After generating the list of matching and authorized devices, the orchestration server sends a response back to the client device 103 as a web page with a list of available devices 221 with their DEVICE_NAME 305 and links to a setup device 111 located on the LOCAL_ADDRESS 307. It is preferably in terms of user experience to refer to the devices by the most recognizable name, for instance, in terms of brand or connected interaction device, e.g. Sugarcube™ or TV. This is one area where the DEVICE_NAME 305 element shows its usefulness. The client device 103 receives the web page with a list of available devices 223. A user 105 then selects the device they wish to use 225 and behind the scenes are connected to the setup device 111 because of the LOCAL_ADDRESS 307 in the response web page of available devices 223. If there is only one device registered with the orchestration server 101 or the user has previously indicated their preference to only use this device, they may be immediately connected to a setup device 111 which receives the connection request 227.

The setup device 111 receives the connection request 227 from the client device 103 which for the purposes of illustration in this embodiment connects to the setup device 111, which in this embodiment presents an interface as a web page. The setup device 111 sends a request for content 229 to the client device 103. In this embodiment, this request for content 231 received by the client device 103 appears as a webpage to the user 105. The user 105 then selects content 233 from the client device memory 803, a third-party source, URL or other appropriate location and sends it to the setup device 111 which in this embodiment is a video file. The setup device 111 receives the content 235 and then sends it to the connected interaction device 237. A connected interaction device 115 in this embodiment being a TV, as described previously, connected through a HDMI™ connection 117 to the setup device 111 plays the content which is a video file in this embodiment. The setup device 111 sends feedback to the client device 239 which in this embodiment, is a web page with the playback state of the video, including play time, time remaining and volume controls, to the client device 103. The user 105 may choose to select and send different content 233 repeating the previous process. Or the user 105 may choose to interact with currently presented content by sending an interaction request 243 to the setup device 111 such as fast forwarding the video in the embodiment. The setup server 111 receives the interaction request 245 and completes the action of rewinding the video to the chosen time and then sends feedback 239 to the client device 103. The client device 103 once again receives the feedback 241 of the current state of the presented media. If the state of the setup device or presented media change, the setup device 111 may update the client device by sending feedback 239 asynchronously and immediately without any interaction from the client device 103. Finally, the user 105 may choose to end sharing 247 thus completing the sharing experience.

### Other Embodiments

Other embodiments of the invention are described in this section. Another embodiment is illustrated in FIG. 4 where there is a separate network A 407 is connected to the primary network 109. This embodiment may occur at an office where there is an isolated guest network for guests such as user A 403A whereas employees such as user B 403B are connected to the network 109. For security devices on network A 407 may access the Internet but may not access devices on network 109. However, a guest, might require presenting content to an interaction device 115 connected to a setup device 111 on network 109. To accomplish this the orchestration server 101 can accept connections from client devices 401A on network A 407 by using subnet matching of the ROUTE 311. This prevents the necessity of enabling complete access to network 109 from devices connected to network A 407 or giving guest devices access to the network 109 which is a security risk. This also allows firewalls to be in place between network A 407 and the network 109, maintaining security while enhancing the user experience for guests by allowing them to easily share content. An use case for this is a salesperson coming into an office to present information on their new product.

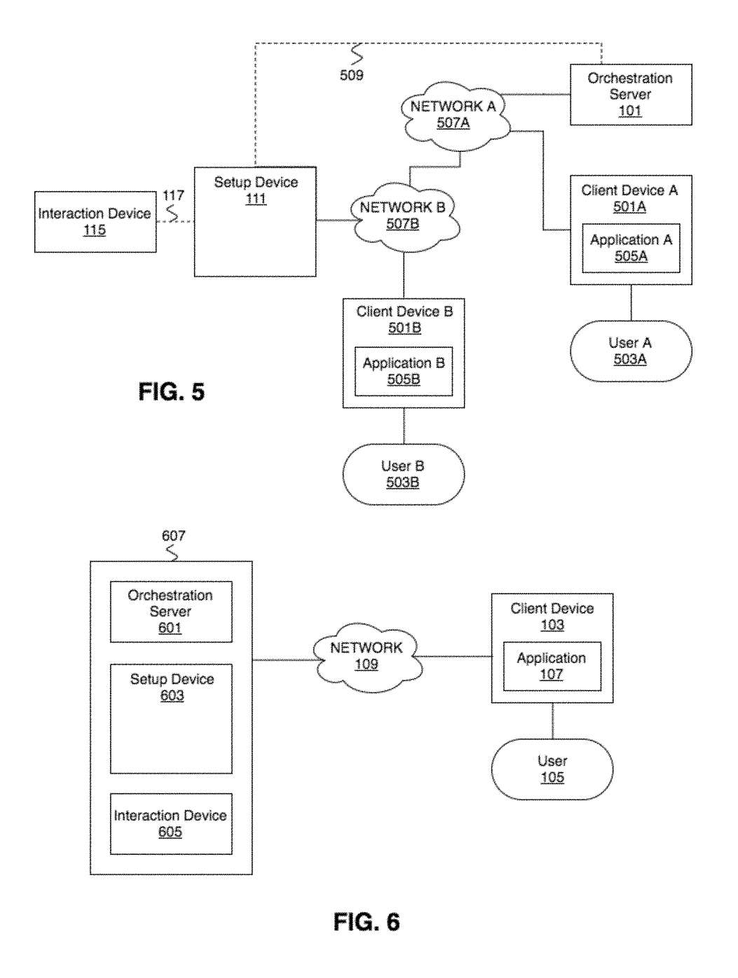

Another embodiment of the invention is illustrated in FIG. 5 where network A 507A is isolated from network B 507B so devices on one network cannot communicate with one another. However, the setup device 111 is able to send an outgoing connection to the orchestration server 101 and because this is possible, the orchestration server 101 may request the setup device to establish a long term connection to communicate responses to the setup device 111. This is accomplished by a reverse secure shell (SSH) tunnel 509 using the SSH module. With the reverse SSH tunnel in place, client device A 501A may share content to interaction device 115 connected to setup device 111 via an interaction connection 117 by connection to the orchestration server 101 and sending content over the reverse SSH tunnel 509. This embodiment may be useful for accessing your home network, securely while travelling.

Another embodiment of the invention illustrated in FIG. 6 shows a device where the orchestration server 601, setup device 603 and interaction device 605 are integrated into a single device 607. Other configurations are possible in various combinations as ideal for the product and it use.

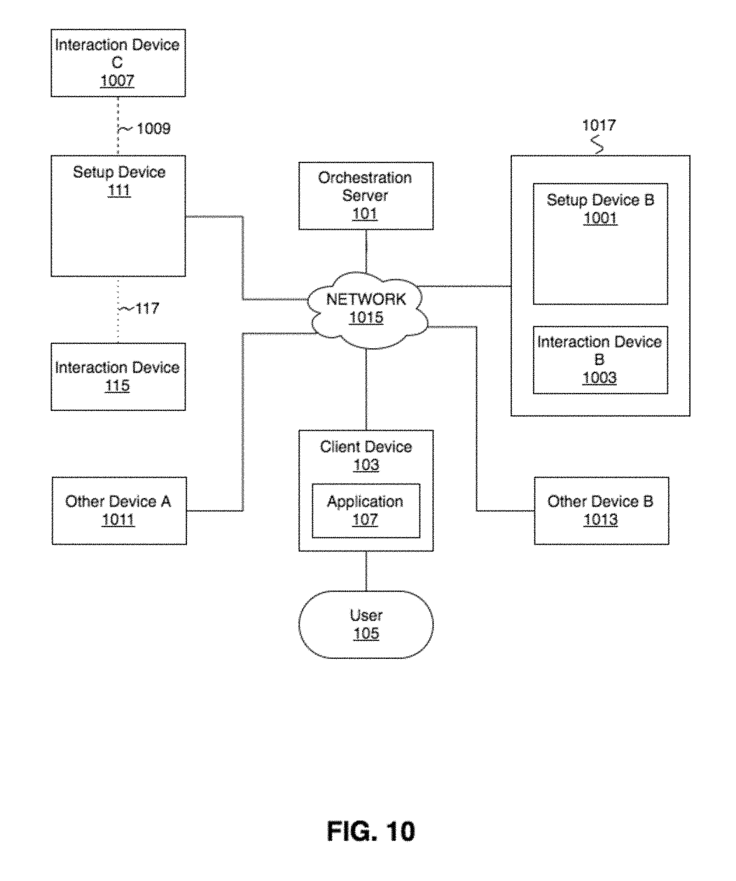

Another embodiment of the invention illustrated in FIG. 10 shows a system which may be used in a typical network 1015 with multiple setup devices 111, 1001; multiple interaction devices 115, 1003, 1007 and other network connected devices which do not have setup device capabilities. The setup devices are connected to various interaction devices or are themselves interaction devices 1017. It is beneficial to be able to use and maintain other network connected devices 1011, 1013 through the orchestration server 101. Since the setup devices 111, 1001 are able to scan for orchestration severs, in the process they may discover other network connected devices using interfaces found on common ports such as HTTP (80), HTTPS (443), FTP (21), etc. Upon successful connection, they may also be registered with the orchestration server 101 enabling ease of discovery and use.

### Alternative Applications

The features and advantages described in the specification are not all inclusive and in particular, many additional features and advantages will be apparent to one of ordinary skill in the art in view of the drawings, specification, and claims. Those skilled in the art will be able to employ to modifications to improve security, reliability and/or performance, etc. Such modifications for are still other embodiments and the underlying principles of the invention are still present. Moreover, it should be noted that the language used in the specification has been principally selected for readability and instructional purposes, and may not have been selected to delineate or circumscribe the inventive subject matter.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope for the invention be limited not by this detailed description, but rather by any claims that issue on an application based hereon. Accordingly, the disclosure of the embodiments of the invention are intended to be illustrative but not limiting, of the scope of the invention, which is set forth in the following claims.

1. A computer implemented method comprising:
registering a network connected device with another device;

2. The computer implemented method of claim 1, further comprising:
sending requests to register periodically in time.

3. The computer implemented method of claim 1, further comprising:
Responsive to a registration request timing out, resending the request one or more time.

4. A computer implemented method comprising:
scanning a network to discover other network connected devices.

5. The computer implemented method of claim 4, further comprising:
discovery by connecting to service on ports of an address

6. A computer implemented method comprising:
connecting to a local device by mean of another device

7. The computer implemented method of claim 6, further comprising:
connecting to a device through means of another device by means of connection established from device to other device

8. The computer implemented method of claim 6, further comprising:
sending content to another device

9. The computer implemented method of claim 6, further comprising:
receiving feedback and interacting with another device
